(19) United States
(12) Patent Application Publication
(10) Pub. No.: US 2010/0318535 A1
(43) Pub. Date: Dec. 16, 2010

(54) PROVIDING SEARCH RESULTS TO A COMPUTING DEVICE

(75) Inventors: Karon Weber, Kirkland, WA (US); Katrika Woodcock, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/483,070

(22) Filed: Jun. 11, 2009

(51) Int. Cl. G06F 17/30

(52) U.S. Cl. 707/759; 707/769; 707/919

(57) ABSTRACT

Systems and methods for providing search results to a mobile computing device are provided herein. One exemplary method includes receiving a search request from the mobile computing device, where the search request includes location data identifying a location of the mobile computing device. If the search request includes an explicit search query, the method includes associating candidate search information derived from the explicit search query with the location identified by the location data of the search request. If the search request includes an explicit search query, the method also includes sending query-based search results to the mobile computing device. If the search request includes an implicit search query, the method includes sending location-based search results to the mobile computing device. The location-based search results are derived from candidate search information associated with the location identified by the location data.

### BACKGROUND

Performing a basic keyword search of a searchable database can result in an excess of search results, which a user can then manually filter in order to discover the search results most relevant to him/her. Manually filtering search results may lead to discovering search results which are inappropriate for a user's context, situation or location. Furthermore, manually filtering search results can be bothersome and time-consuming, leading to user frustration.

### SUMMARY

Providing location-aware search results to a mobile computing device is provided herein. One exemplary method includes receiving a search request from the mobile computing device, where the search request includes location data identifying a location of the mobile computing device. If the search request includes an explicit search query, the method includes associating candidate search information derived from the explicit search query with the location identified by the location data of the search request. The method also includes sending query-based search results to the mobile computing device if the search request includes an explicit search query. If the search request includes an implicit search query, the method includes sending location-based search results to the mobile computing device. The location-based search results are derived from candidate search information associated with the location identified by the location data.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of an exemplary time series of events related to an explicit search query.

FIG. 2 is a schematic view of an exemplary time series of events related to an implicit search query.

FIG. 3 is a flowchart illustrating an exemplary method for providing search results to a mobile computing device.

FIG. 4 is a schematic view of a system including a server for delivering query-based search results to a mobile computing device.

FIG. 5 is a schematic view of a system including a server for delivering location-based search results to a mobile computing device.

### DETAILED DESCRIPTION

Current location-based digital searching techniques include point-of-interest look-up searches and business look-up searches. While such searches are adequate in some scenarios, such search methodologies may not provide desired results in all scenarios. A method for harvesting the power of community data by using location data of searches performed by previous searchers (e.g., a community), to thereby improve quality and relevancy of new search results, is provided herein. As described in more detail below, the disclosed search methodology can provide search results that are at least partially based on what others have thought was important for a particular location.

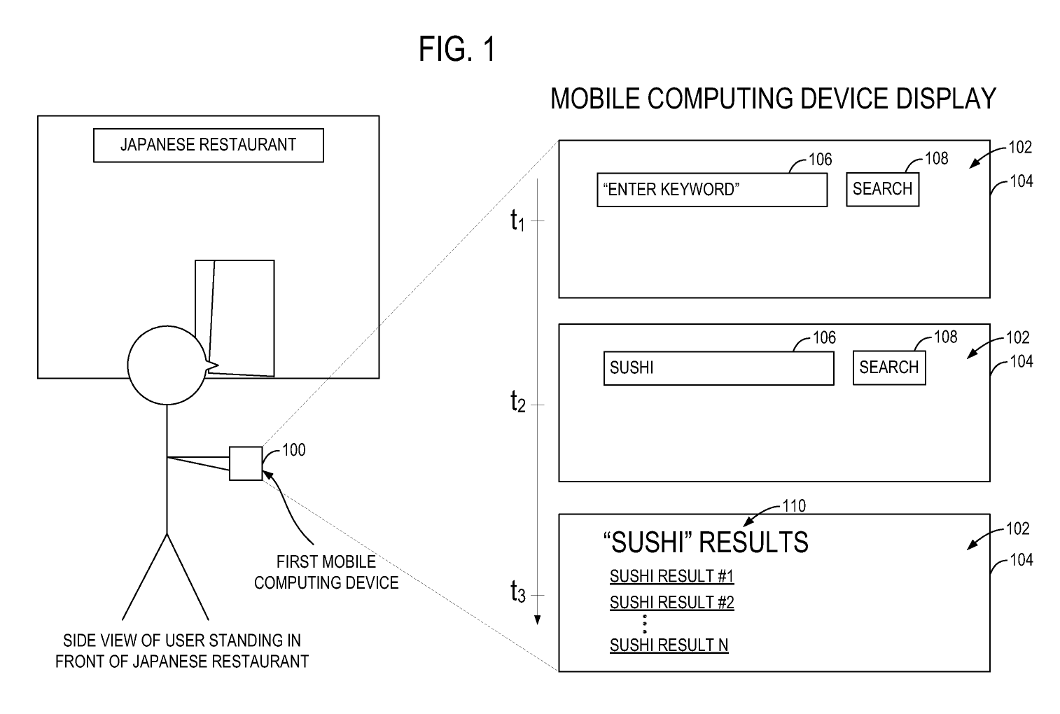

FIG. 1 illustrates a schematic view of an exemplary time series of events related to an explicit search query. A side view of a user standing in front of a Japanese restaurant holding a first mobile computing device 100 is shown. A graphical user interface 102 of a display 104 of the first mobile computing device 100 is shown at times t₁, t₂, and t₃ on the right side of FIG. 1.

At t₁, the user may be presented with a graphical user interface 102 prompting entry of a search keyword into a text entry box 106 to search a database for search results. At t₂, the user enters the keyword “sushi” into the text entry box 106 and actuates a search button 108. Actuation of the search button 108 may occur via touch input, mouse click, or any other suitable input. Actuation of the search button 108 may cause a search request including an explicit search query (e.g., including user-selected search terms such as “sushi”, etc.) to be sent to a server across a network (e.g., the Internet).

As a result, at t₃, a plurality of links 110 to query-based search results related to sushi are presented on the graphical user interface 102 of the display 104. The user can select any of these sushi-related search results (e.g., via selection of a hyperlink) for more information. Although the links to the query-based search results (e.g., “sushi result #1”, “sushi result #2”, “sushi result #N”) are schematically shown as hyperlinks, it may be appreciated that the query-based search results displayed on a graphical user interface may be any combination of selectable and non-selectable text and/or graphics. Such query-based search results may be selected on the server side using virtually any search engine technology without departing from the spirit of this disclosure.

When the search request is sent to the server across the network, the search request may also include the location of the first mobile computing device 100 and/or mobile computing device user as well as the time (e.g., time of day, time of year, etc.) that the search request was sent. As a result, the search keyword(s), search results, and/or intermediary search codes may be associated with the location of the first mobile computing device 100 and/or the time that the search request was sent. In this way, the server generating the query-based search results can learn what type of information mobile computing device users at that particular location, or nearby locations, and may typically desire at that time, or near that time. Thereafter, the server may use the learned information to provide location-based and/or time-based search results to the first mobile computing device and/or to other mobile computing devices. In other words, the explicit, query-based searches of some users may be used to train a server to provide location-aware search results for other users.

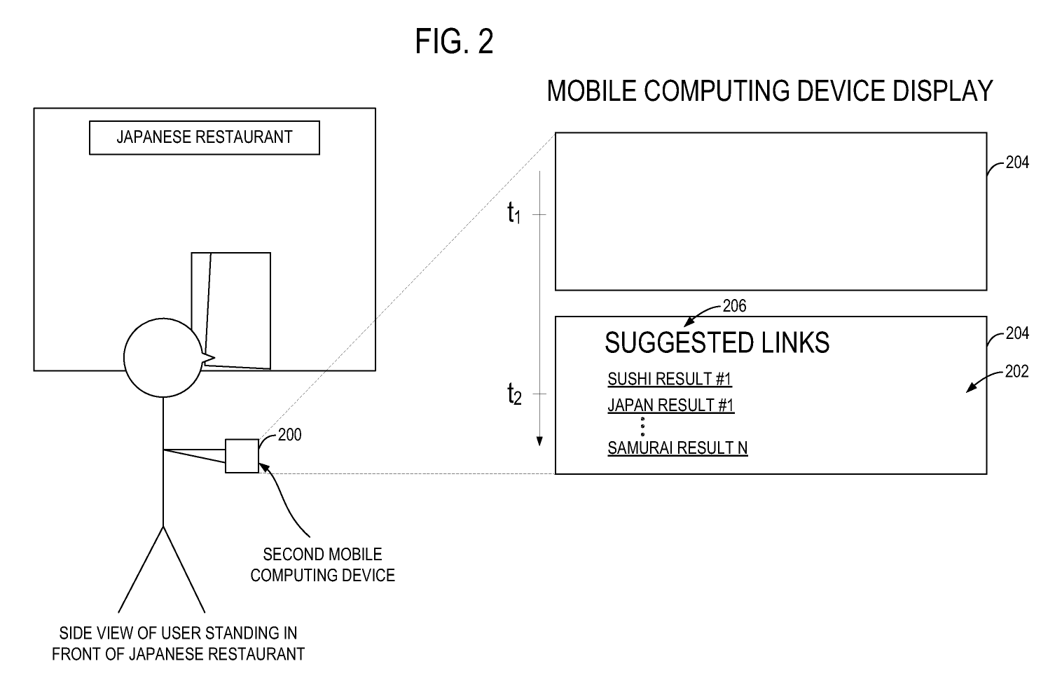

Referring now to FIG. 2, a schematic view of a second user holding a second mobile computing device 200 is shown in front of the same Japanese restaurant as that shown in FIG. 1. At t₁, a second display 204 of the second mobile computing device 200 may appear blank or darkened because the mobile computing device is asleep, for example. At t₂, the user may “wake-up” (e.g., shake, actuate a wake-up button, etc.) the second mobile computing device 200, and the second mobile computing device 200 may automatically send a second search request with an implicit search query to the server described with respect to FIG. 1.

An implicit search query need not include user-selected search terms but, rather, the implicit search query may include the second mobile client user's location and a time of the second search request by which search terms are implied. That is, the server may generate search results based on the location and/or time information received at the server. The server can then send the search results to the mobile computing device 200, even though the user did not provide any user-selected search terms to be searched. As a result, the second mobile computing device 200 may display a graphical user interface 202 with suggested links 206 to access location-based search results (e.g., “sushi result #1”, “Japan result #1”, “samurai result #N”) at t₂.

The suggested links 206, including sushi result #1, Japan result #2, and samurai #N may be location-based search results. That is, they may have been based on candidate search information derived from, for example, the first search request of FIG. 1 sent from the same, or similar, location as the location of the second search request. Further, sushi result #1 may be provided as one of the suggested links 206 because many previous search requests from mobile computing devices at that location produced sushi result #1. Thus, although the second mobile computing device user has provided minimal, or no explicit information, the second mobile computing device user is provided with information s/he is likely to be interested in, or likely to search for.

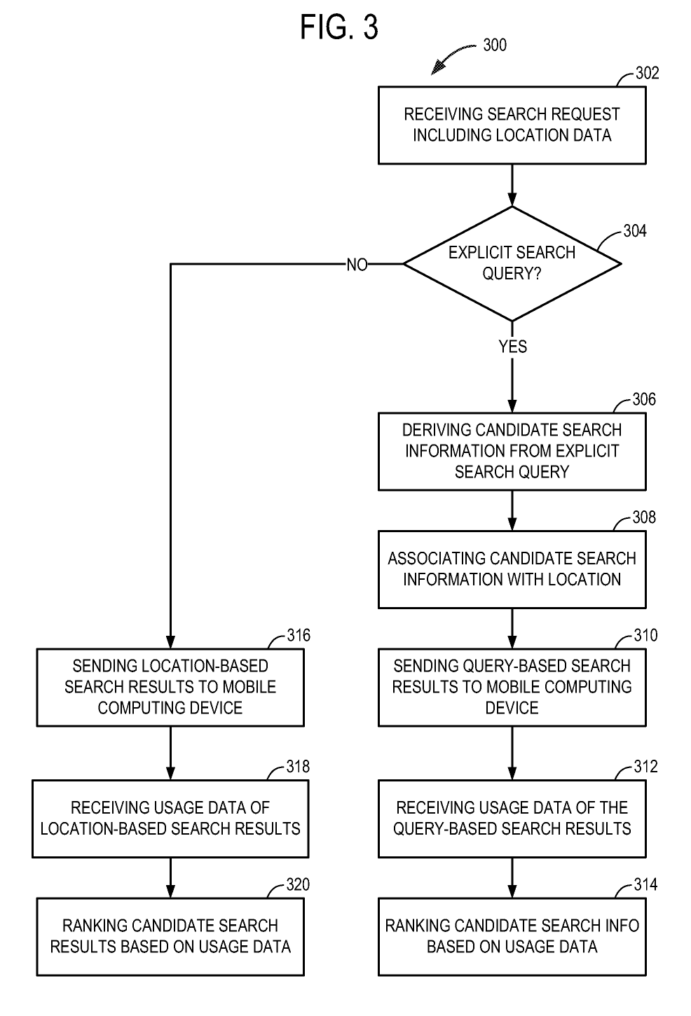

Turning now to FIG. 3, a flowchart illustrates an exemplary method 300 for providing search results to a mobile computing device. The method 300 includes receiving a search request from the mobile computing device at a server. The search request includes location data identifying a location of the mobile computing device. Location data may include a precise geographical location, such as the longitude and latitude of the mobile computing device. In other examples, the location identified by the location data may be a geographical zone, such as a predefined area of space, or a region defined by street boundaries.

At 304, the method 300 includes determining if the search request includes an explicit search query. If the answer is yes at 304, the method 300 includes deriving candidate search information from the explicit search query at 306. In some examples, candidate search information may include keywords included in the explicit search query, and/or contextual information (e.g., tourist attractions close to the location identified by the location data, etc.) as some examples. Query-based search results generated responsive to a search request may also be considered, or included in, candidate search information.

The method 300 further includes associating the candidate search information with the location identified by the location data, at 308. The method 300 may also include associating the candidate search information with the time identified by the temporal data if temporal data indicating a time of the search request is also received in the search request.

At 310, the method 300 includes sending the query-based search results to the mobile computing device for display. The query-based search results may be selected by the server using any suitable search engine technology. Because, in this scenario, the user provided explicit search terms and requested that those terms be searched, the search results will be derived from the search terms in accordance with the searching techniques/algorithms employed by the server. In some embodiments, location information may be used to disambiguate or otherwise tailor the results, but with consideration of the explicit search terms.

By receiving location data in the search request at the server, disambiguated search results can be returned to the mobile computing device. For example, a user of a mobile computing device seeking information while at a zoo may enter “cat” into a text entry box of a graphical user interface of the mobile computing device, and actuate a search actuation button. Thus, a search request including an explicit search query and location data identifying the zoo as the mobile client location is sent to a server. At the server, the search results may be filtered to primarily include search results relevant to wild cats. This may occur based on heuristics or statistics indicating a likelihood that a mobile computing device user is most interested in wildcats when at a zoo.

However, if such an explicit search query (e.g., for “cat”) is received when a mobile computing device user is at a residence, the search results may be filtered at the server to primarily include search results relevant to domestic cats. This may occur as a result of a likelihood that a mobile computing device user is most interested in domestic cats when at the residence. That is, based on location data, a mobile computing device sending a search request and/or a server generating search results can predict or contextualize search results based on location. It may be appreciated that search results can be filtered as described based on location data at a mobile computing device or at a server identifying the location represented by the location data.

Once a mobile computing device receives the query-based search results, a user of the mobile computing device can interact with a graphical user interface of a display of the mobile computing device by, for example, actuating a link to the query-based search results. Such user behavior, or input, can be reported, by the mobile computing device, to the server. Accordingly, the method 300 may include at step 312, receiving usage data of the query-based search results from the mobile computing device at the server (e.g., based on which query-based search results the user decided to view, how long the user viewed information associated with such query-based search results, whether the user bookmarked or otherwise favored a particular result, etc.). In other examples, a user may be invited to rank the query-based search results via a graphical user interface on a display of a mobile computing device. For example, the user may be invited to rank the query-based search results as “helpful” or “not helpful”, or by using a numeric scale (e.g., 4/5 stars, 9/10 points, etc.) or nominal ranking scale (e.g., very good, very bad, etc). Such a user ranking input may also be included in the usage data received at the server at step 312.

At 314, the method 300 may thus include ranking candidate search information at the server based on the usage data (e.g., usage frequencies of a given search result from which the candidate search information is derived). In this way, future query-based search results can be selected for sending to a mobile computing device based on which query-based search results previous users interacted with and/or found helpful when sending search requests from that mobile computing device location. For example, candidate search information may include a website page and the website's page ranking within a list of ranked website pages may be increased if a predetermined amount, or percentage, of mobile computing device users chooses to view said website page responsive to receiving a link to said website page.

It may be appreciated that candidate search information may also be ranked, at a server, based on an explicit search query frequency. For example, if a predetermined number of explicit search queries received from mobile computing devices while located near a Japanese restaurant include the keyword “sushi” in the keyword search, the keyword “sushi” may be a highly ranked form of candidate search information associated with that mobile computing device location. Accordingly, location-based search results sent from mobile computing devices in front of the Japanese restaurant may include at least one sushi-related search result.

The ranking of candidate search results at 314 may also be used to derive location-based search results, and to thereby assist in the server's selection, or generation of relevant location-based search results, as will be discussed below.

If the answer is no at 304, the search request may include an implicit search query (e.g., not including user-selected or user-inputted search terms). That is, a user may have woken up the mobile computing device and/or pressed a search button actuator without entering a keyword in a text entry box of a graphical user interface. As a result, the method 300 may include sending location-based search results to the mobile computing device from a server, at 316. While waking of the mobile device and pressing a search button actuator are provided as two examples, it should be understood that a location-based search request may be sent responsive to virtually any selected event without departing from the spirit of this disclosure.

As mentioned above, the location-based search results may be derived from candidate search information previously associated with the location identified by the location data (e.g., as a result of previous searches performed from a given location). Further, the location-based search results may be derived from candidate search information associated with the time identified by temporal data received in a search request. As some examples, location-based search results may be selected from a list, or database, of highly-ranked candidate search information associated with the location identified by the location data sent in the search request with the implicit search query.

Thereafter, the method 300 may include receiving the usage data of the location-based search results at the server at 318. Here, the usage data may be similar to that described with reference to step 312, but resulting from a location-based search as opposed to a query-based search. Thus, at 320, the method 300 may include ranking the candidate search results, at the server, based on the usage data of the location-based search results and/or the usage data accumulated from previous location-based and/or query-based searches.

Numerous factors related to location may be included in location data sent in a search request with an explicit or implicit search query. For example, location data sent from a mobile computing device and/or a location identified by location data at a server receiving the search request may include a geographical class of the device, such as “rural”, “urban”, “inside”, or “outside” (i.e., device side classing). In some embodiments, the server may recognize a specified location data as being associated with a particular geographical class (i.e., server side classing). In some embodiments, the location is reported as raw data, such as a latitude and longitude, an IP address that can be geo-inferred, etc. (e.g., with no classing). In all such cases, by knowing the location and/or context of a mobile computing device, a server may filter query-based search results and location-based search results based on the location and/or context such that the search results sent to a mobile computing device are most relevant for that location and/or context.

Further still, location data may include an orientation of a mobile computing device. For example, if a user is inside a museum and facing toward a Van Gogh painting, a search request including an implicit search query may be received at a server from the user's mobile computing device. The server may then send location-based search results related to Van Gogh to the mobile computing device. However, if the user is standing outside of and facing toward the same museum, and the server receives a search request including an implicit search query from the mobile computing device, the server may return location-based search results including the museum's operating hours. That is, the user's orientation toward the museum, in this example, may be used to infer what type of information the user may be interested in.

In this example where a user is standing in front of the museum, the search results may also include information about a gallery two blocks away from the mobile computing device's precise location. That is, the location identified by the location data may be scaled, at the server, based on the location data (e.g., geographical class of “inside” vs. “outside”) received from the mobile computing device, and search results can be based appropriately on the scaled location.

A location identified by the location data can be further scaled based on a location density. For example, if a mobile computing device user is travelling within New York City and a mobile computing device sends an implicit search query to a server, the location identified by location data sent from the mobile computing device may be scaled to a two-block radius, such that location-based search results associated with locations in the two-block radius are returned to the mobile computing device. However, if a mobile computing device user is travelling in rural Idaho, the location identified by location data sent from the mobile computing device may be scaled to include a 100-mile radius. It may be appreciated that the location data can be scaled at the mobile computing device prior to sending the location data to the server, or the location identified by the location data can be scaled at the server. Also, a user may indicate a particular location scaling preference (e.g., auto-scaling based on location density, manual scaling, etc.) as a user preference. In another example, a radius preference and/or a proximity preference can be included as a user preference.

As another example, location data may include a travelling route upon which the mobile computing device is travelling. In this example, location-based search results can be based on candidate search information that has previously been used to generate query-based or location-based search results for mobile computing devices travelling on the travelling route. For example, if a user of a mobile computing device is en route from D.C to New York City, a search request including an implicit search query sent from the mobile computing device may return location-based search results related to traffic conditions at the arrival destination in New York City. Thus, location data may include an arrival location, or a destination location. Further, location-based search results can be based on popular destinations along a travelling route. For example, if a user is driving across a country, the mobile computing device may return location-based search results indicating popular tourist destinations along the travelling route.

Further still, a travel speed of a mobile computing device can be detected by the mobile computing device and/or other receivers, and location data received at a server can include the travel speed. In this way, location-based search results can be timely updated. In another example, a travel speed of a mobile computing device may be included in location data received at a server from a mobile computing device so that query-based or location-based search results can be based on an estimated arrival time at a destination.

It may be appreciated that location data can be used to more accurately filter query-based search results in addition to being used for the filtering of location-based search results.

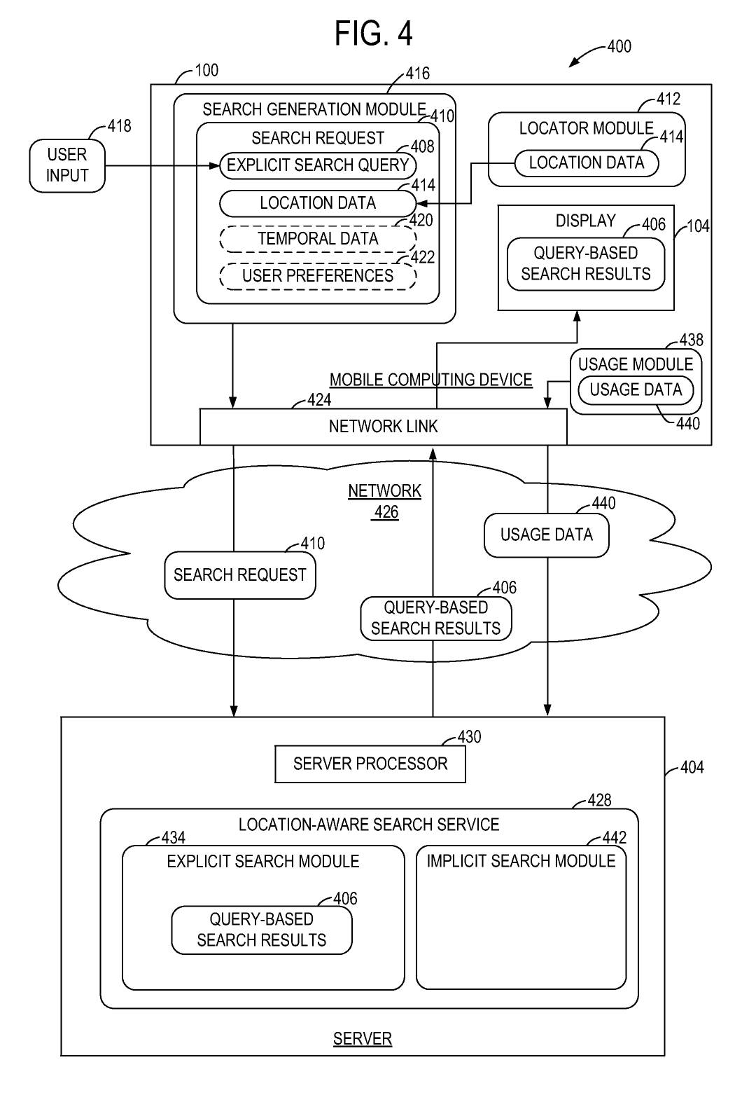

Turning now to FIG. 4, a schematic view of a system 400 including a mobile computing device 100 and a server 404 is shown. An example use case scenario of the system of FIG. 4 is illustrated in FIG. 1 with respect to sending query-based search results 406 to the mobile computing device 100 from the server 404 responsive to receiving a search request 410 including an explicit search query 408 at the server 404.

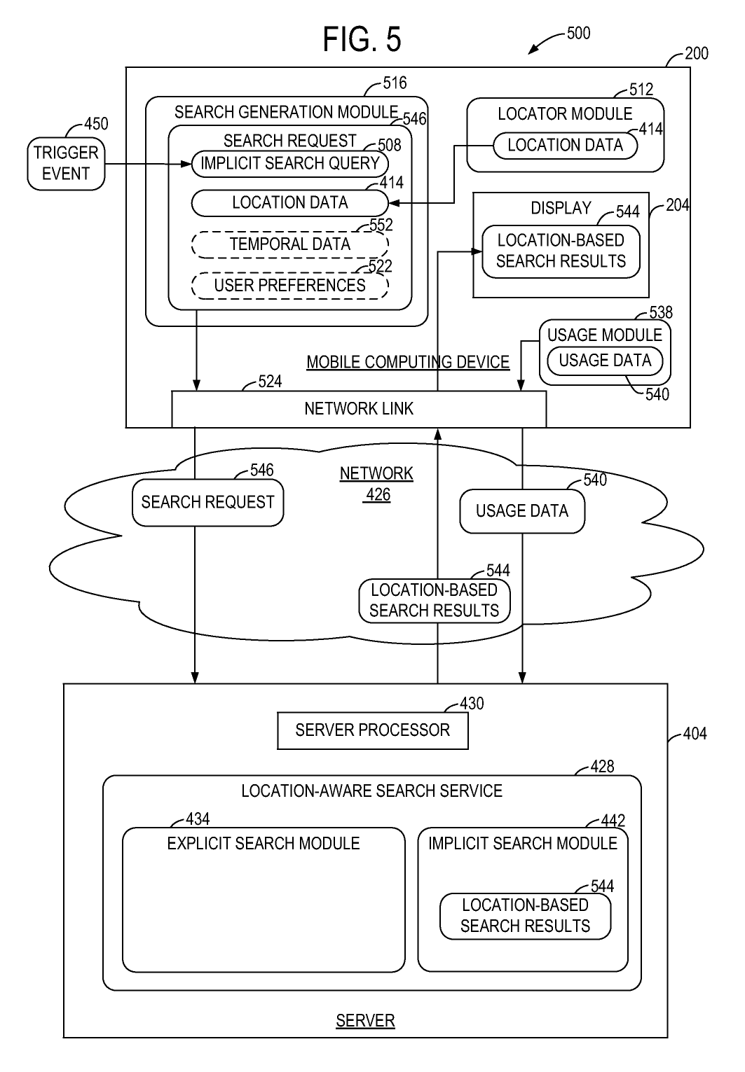

FIG. 5 is a schematic view of a second system 500 including a second mobile computing device 200 and the server 404 of FIG. 4. An example use case scenario of the system of FIG. 5 is illustrated in FIG. 2 with respect to sending location-based search results 444 to the mobile computing device 200 from the server 404 responsive to a second search request 446 including an implicit search query 508.

Similar system components are numbered the same in FIG. 4 and FIG. 5, though it may be appreciated that two independent systems may be used for the use case scenarios described with respect to FIG. 1 and FIG. 2. Furthermore, the same mobile computing device can send a search request including an explicit search query and a search request including an implicit search query.

Specifically, FIG. 4 illustrates the system 400 including a mobile computing device 100 having a locator module 412 to determine location data 414 identifying a location of the mobile computing device 100. The mobile computing device 100 also includes a search generation module 416 for automatically generating a search request 410 responsive to user input 418 indicating a desired search to be performed. In some examples, the user input 418 may be in the form of keyword input and/or actuation of a search button actuator. The search request 410 includes the location data 414 and an explicit search query 408 for query-based search results 406.

The search request 410 may include temporal data 420 identifying a time, or timeframe, of the origination of the search request 410. For example, the temporal data may identify a data range including a particular city festival. A server may be configured to associate candidate search information derived from that search request (e.g., candidate search information related to the city festival) with dates within the date range of the city festival, and to not associate the candidate search information derived from that search request with dates outside of the date range of the city festival.

The search request 410 may also include user preferences 422, such as a user-preferred geographical zone, or a mobile computing device user's preferred “haunt” or neighborhood. In this way, the query-based search results 406 can be tailored to the user's preferred geographical zone if the mobile computing device location is within a predetermined distance from the user-preferred geographical zone. A user may also indicate, as a user preference, to default to the user-preferred geographical zone always, sometimes, or never. Other user preferences may include a user age, user interests, etc. based on user-inputted user preferences or inferred user preferences. The user preferences can be used to filter search results at the server 404.

The search request 410 may be sent to the server 404 via a network link 424 of the mobile computing device 100, over a network 426. The network link 424 may send the search request 410 to a location-aware search service 428 of server 404 via network 426.

The server 404 may include a server processor 430, and the location-aware search service 428 may include code executable by the server processor 430. The location-aware search service 428 may include an explicit search module 434 including code executable by the server processor 430 to receive the search request 410. The explicit search module 434 may further include code executable by the server processor 430 to associate the candidate search information derived from the explicit search query 408 with the location identified by the location data 414 in the search request 410. In other examples, the explicit search module 434 includes code executable by the server processor 430 to associate the candidate search information with the time identified by the temporal data 420 received in the search request 410.

Furthermore, the explicit search module 434 may include code executable by the server processor 430 to send query-based search results 406 to the mobile computing device 100. The network link 424 of the mobile computing device 100 may receive the query-based search results 406 for display on a display 104 of the mobile computing device 100.

Once the query-based search results 406 have been sent to the mobile computing device 100, a usage module 438 of the mobile computing device 100 may track usage data 440 of one or more of the query-based search results 406. Usage data 440 may then be sent from the mobile computing device 100, via the network link 424 to the explicit search module 434 of the location-aware search service 428.

The explicit search module 434 may include code executable by the server processor 430 to receive the usage data 440, such that future query-based search results and future location-based search results can be derived from candidate search information based on the usage data 440.

Server 404 may also include an implicit search module 442 which will be described with respect to FIG. 5.

FIG. 5 is a schematic view of second system 500, for providing location-based search results 444 to mobile computing device 200 responsive to receiving a second search request 446 including an implicit search query 448 at server 404.

Here, the mobile computing device 200 includes a search generation module 516 for automatically generating a search request 546 including an implicit search query 508 responsive to occurrence of a predetermined trigger event 550, such as a wake-up of the mobile computing device 200, activation of a search application of the mobile computing device 200, actuation of a search button actuator, movement to a new location, etc. In other examples, search requests including implicit search queries may be generated at predetermined intervals, or time periods, if the mobile computing device 200 is “awake” or powered on.

The search request 546 includes location data 414 representing the location of the mobile computing device 200, and an implicit search query 508 for location-based search results 544. Although location data 414 of FIG. 5 is represented as the same location data 414 of FIG. 4, it may be appreciated that location data may be different for an explicit search query and an implicit search query, while the location identified by the location data at the server may be the same or similar.

The search request 546 may include temporal data 552 representing a time, or timeframe, of the origination of the search request 546. Thus, the location-based search results 544 can be derived from candidate search information associated with the time identified by temporal data 552. In this way, a collective history of search queries performed by a plurality of mobile computing devices can be leveraged to provide relevant search results.

The search request 546 may also include user preferences 522, such as a user-preferred geographical zone, as discussed with respect to FIG. 4. In this way, the location-based search results can be tailored to a user's preferred geographical zone, if the current location of the mobile computing device is within a predetermined distance from that preferred geographical zone. Other user preferences may include a user age, user interests, etc. based on user-inputted user preferences, as well as inferred user preferences based on the user's interaction with the mobile computing device (e.g., frequent search queries, types of search queries, response to search results, etc.).

Query-based search results, and location-based search results, can be further based on historical user behavior, such as a user's interaction with the mobile computing device (e.g., frequent search queries, types of search queries, response to search results, etc.).

The location-aware search service 428 may include an implicit search module 442 including code executable by the server processor 430 to receive the search request 546. The implicit search module 442 may include code executable by server processor 430 to receive the search request 546 including location data 414 identifying a location of the mobile computing device 200 and the implicit search query 508. The implicit search module 442 may further include code executable by the server processor 430 to send location-based search results 544 derived from candidate search information associated with the location to the mobile computing device 200. The network link 524 of the mobile computing device 200 may receive the location-based search results 544 for display on the display 204, where the display of the mobile computing device 200 may display the location-based search results 544, without further user intervention. That is, the location-based search results 544 may be displayed on the display 204 without further user input or an additional predetermined triggering event, such as an additional device wake-up gesture, search application activation, actuation of button actuator, etc.

Once the location-based search results 544 have been sent to the mobile computing device 200, the usage module 538 of the mobile computing device 200 may track usage data 540 of one or more of the location-based search results 444. Usage data 540 may then be sent from the mobile computing device 200, via the network link 524 to the location-aware search service 428. In some cases, this usage data 540 is sent to explicit search module 434. In any case, the location-aware search service 428 may include code executable by the server processor 430 to receive the usage data 540, such that future query-based and/or location-based search results can be derived from the candidate search information based on the usage data 540.

As illustrated, one server may include an explicit search module, an implicit search module server, and a server processor. In other examples, the explicit search module and the implicit search module may reside on independent servers with independent processors configured to interoperate with one another to achieve the methods and processes described herein. In yet another example, one server may include an explicit search module and an implicit search module and a processor for executing code of the respective modules.

Although a system illustrating provision of query-based search results in FIG. 4 and location-based search results in FIG. 5 is illustrated as having two different mobile computing devices, it may be appreciated that a same mobile computing device may interact with one or more server for providing query-based search results and location based search results.

The location data identifying the location of the mobile device may take a variety of different forms without departing from the spirit of this disclosure. In some embodiments, the location data may include latitude and longitude information obtained from a GPS. In some embodiments, the location data may include IP address, cell phone tower triangulation, etc. The level of precision may vary depending on the technology used to determine the location of the mobile device. It is to be understood that a server may identify a location with location data received from two or more different mobile devices in two different positions. For example, two mobile devices may be in front of the same restaurant, but at slightly different positions. If the resolution of the devices is capable of distinguishing between the slightly different positions, the devices may send slightly different location data. Nonetheless, the server may be trained to interpret both positions as being part of the same location, so that the same location-based search results may be sent to both devices.

It will be appreciated that the mobile computing devices and servers described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A method of providing search results to a mobile computing device, the method comprising:
receiving a search request from the mobile computing device, the search request including location data identifying a location of the mobile computing device;
if the search request includes an explicit search query:
associating candidate search information derived from the explicit search query with the location identified by the location data; and
sending query-based search results to the mobile computing device; and
if the search request includes an implicit search query:
sending location-based search results to the mobile computing device, the location-based search results derived from candidate search information associated with the location identified by the location data.

2. The method of claim 1, where the search request further includes temporal data identifying a time, and where the associating includes associating candidate search information with the time identified by the temporal data, and where the location-based search results are further derived from candidate search information associated with the time.

3. The method of claim 1, further comprising receiving usage data of the query-based search results and/or the location-based search results from the mobile computing device, and ranking the candidate search information based on the usage data, where the location-based search results are derived from candidate search information based on ranking of candidate search information.

4. The method of claim 1, where the search request includes user preferences, and the location-based search results are based on user preferences.

5. The method of claim 4, where the user preferences include at least one user-preferred geographical zone.

6. The method of claim 1, where the location identified by the location data is a geographical zone.

7. The method of claim 1, where the location identified by the location data is a geographical class.

8. The method of claim 1, where the location-based search results are further based on historical user behavior.

9. A mobile computing device comprising:
a locator module to determine location data identifying a location of the mobile computing device;
a search generation module for automatically generating a search request responsive to occurrence of a predetermined trigger event, the search request including the location data and an implicit search query for location-based search results;
a network link for sending the search request to a location-aware search service via a network and for receiving location-based search results from the location-aware search service; and
a display for displaying the location-based search results, without further user intervention.

10. The mobile computing device of claim 9, where the predetermined trigger event is a wake-up of the mobile computing device.

11. The mobile computing device of claim 9, where the predetermined trigger event is an activation of a search application of the mobile computing device.

12. The mobile computing device of claim 9, where the search request further includes temporal data.

13. The mobile computing device of claim 9, where the search request further includes user preferences.

14. The mobile computing device of claim 13, where the user preferences include a user-preferred geographical zone.

15. The mobile computing device of claim 9, where the location data includes a geographical zone.

16. The mobile computing device of claim 9, where location data includes a geographical class.

17. The mobile computing device of claim 9, further comprising a usage module for tracking usage data of a location-based search result, where the network link sends the usage data to the location-aware search service.

18. A server comprising:
a processor;
a location-aware search service including:
an explicit search module including code executable by the processor to receive a search request including location data identifying a location of the mobile computing device and an explicit search query, associate candidate search information derived from the explicit search query with the location, and send query-based search results to the mobile computing device; and
an implicit search module including code executable by the processor to receive a search request including location data identifying a location of the mobile computing device and an implicit search query, and send location-based search results derived from candidate search information associated with the location to the mobile computing device.

19. The server of claim 18, where the search request further includes temporal data identifying a time, and where the explicit search module also includes code executable by the processor to associate candidate search information with the time, and where the location-based search results are further derived from candidate search information associated with the time.

20. The server of claim 18, where the explicit search module also includes code executable by the processor to receive usage data regarding usage of query-based search results and/or location-based search results, and where the location-based search results are derived from candidate search information based on the usage data.
